(19) United States
(12) Patent Application Publication
(10) Pub. No.: US 2012/0291588 A1
(43) Pub. Date: Nov. 22, 2012

(54) Bicycle windscreen with handlebar mount

(76) Inventor: MARK CUTINO, BRENTWOOD, CA (US)

(21) Appl. No.: 13/068,813

(22) Filed: May 20, 2011

(51) Int. Cl. B62J 17/04; B62J 17/00; B62J 23/00; B62J 17/02

(52) U.S. Cl. 74/551.8

(57) ABSTRACT

A bicycle windscreen is secured to the handlebars of the bicycle to protect the hands and forearms of the bicycle rider from the constant chilling effect of the passing airstream. It includes a thin panel forming a central portion curved about the horizontal portions of the handlebars,. A pair of bell-like end portions are secured to respective ends of the central portion, and extend about and are spaced apart from the brake lever mechanisms, and protect the rider's hands when resting on the brake mechanisms or drop handles. A pair of standoffs extend between the central portion and the handlebar assembly, and a pair of cable ties are anchored in the central portion and passed about the handlebar assembly to secure the windscreen to the handlebar assembly. Another pair of cable ties extend laterally from the bell end portions to the handlebar assembly to maintain the windscreen in a tension/suspension arrangement.

### CROSS-REFERENCE TO RELATED APPLICATIONS

Not applicable.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to streamlined fairings for bicycles and, more particularly, to bicycle windscreens that are mounted on the handlebars of a bicycle.

2. Description of Related Art

Bicycles are characterized as lightweight, human-powered vehicles, and as such they are limited in propulsion power by the strength and endurance of the bicycle rider. An average bicycle rider can sustain a pedaling effort that is substantially less than one horsepower, a fact that limits bicycle speeds to generally safe limits. In addition, the effects of wind resistance increase with the square of the velocity, and for most riders the drag of wind resistance becomes noticeable at speeds above 10-15 mph (16-24 kph). The wind resistance combined with the low propulsion power of a typical cyclist results in generally low average speeds for a bicycle.

In order to ameliorate the high aerodynamic drag, bicycle windscreens have been developed in the prior art. Many of these devices are fairings attached to the bicycle frame or front forks or handlebars, and comprise smoothly contoured convex shells that seek to divert the (apparently) onrushing air into streamlines that pass around the rider's body in the most low-friction manner that can be obtained. But the decrease in air resistance is achieved at some cost. Fairings are generally only effective with respect to an air stream onrushing from dead ahead; the fairings may be adversely affected by winds from the side quarters. Often the mounting hardware for a windscreen also adds weight to the bicycle.

There is clearly a tradeoff between the added total weight of a fairing assembly and the reduction in aerodynamic drag that the windscreen provides. In addition, a fairing may isolate a bicycle rider from the passing airstream, denying the rider the advantage of the passing breeze to remove the considerable amount of heat generated by a rider.

It is generally acknowledged that bicycle riders often experience feelings of coldness and numbness in their hands and arms. This is due in part to the fact that the hands and arms are used to maintain a grip on the handlebars and to operate the gear selectors and brakes, but are primarily immobile on the handlebars, so that blood circulation to those limbs is not promoted. At the same time, the hands and arms are subjected to the airflow from the bicycle's forward velocity, and can become chilled by this constant cooling effect.

Thus although large fairings may be problematic for many riders, or may be desirable only in limited riding situations, there is a need to protect the hands and arms of the rider from the steady cooling effect of the passing air stream. The prior art appears deficient in providing windscreens designed in particular to protect the hands and arms of a rider.

### BRIEF SUMMARY OF THE INVENTION

The present invention generally comprises a bicycle windscreen that is secured to the handlebars of the bicycle. The windscreen is designed primarily to protect the hands and forearms of the bicycle rider from the constant chilling effect of the passing airstream on those exposed, stationary limbs. The windscreen features minimal weight and mass, and does not interfere with or affect control of the handlebars.

In one embodiment the windscreen includes a thin panel forming a central portion extending parallel to the horizontal portions of the handlebars, the central portion being curved about a horizontal axis and presenting a smooth convex surface to the oncoming airstream of the bicycle. A pair of bell-like end portions are secured to respective ends of the central portion, each end portion having a compound curvature that mimics the curvature of central manifold 33 about the horizontal axis, and also is curved about a generally vertical axis. The end portions extend about and are spaced apart from the brake lever mechanisms, and protect the rider's hands when resting on the brake mechanisms or drop handles. A pair of standoffs extend between the central portion and the handlebar assembly, and a pair of cable ties are anchored in the central portion and passed about the handlebar assembly to secure the windscreen to the handlebar assembly. Another pair of cable ties extend laterally from the bell end portions to the handlebar assembly to maintain the windscreen in a tension/suspension arrangement.

A further embodiment of the windscreen includes a coffer-like shell having a convex outer surface to deflect the oncoming airstream, and is dimensioned to extend only to protect the horizontal portions of the handlebar assembly. Another embodiment for use with an aerobar handlebar rest includes a coffer-like shell opening upwardly, and straps or ties securing the windscreen to the bars of the aerobar assembly.

### BRIEF DESCRIPTION OF THE DRAWING

FIG. 1 is a perspective view of one embodiment of the windscreen assembly of the present invention.

FIG. 2 is an exploded perspective view of the embodiment of FIG. 1 shown together with a typical bicycle handlebar assembly.

FIG. 3 is a top view of the embodiment of FIGS. 1 and 2, shown assembled to the typical handlebar assembly of FIG. 2.

FIG. 4 is a side elevation of the embodiment of FIGS. 1-3, shown assembled to the typical handlebar assembly.

FIG. 5 is a perspective front quarter view of a another embodiment of the windscreen assembly of the present invention.

FIG. 6 is a rear quarter perspective view of the embodiment of FIG. 5.

FIG. 7 is a top view of the embodiment of FIGS. 5 and 6, shown assembled to the typical handlebar assembly.

FIG. 8 is a side elevation of the embodiment of FIGS. 5-7, shown assembled to a typical handlebar assembly.

FIG. 9 is a front quarter perspective view of a further embodiment of the windscreen assembly of the present invention.

FIG. 10 is a rear quarter perspective view of the embodiment of the windscreen assembly of FIG. 9.

FIG. 11 is a top view of the embodiment of FIGS. 9 and 10, shown assembled to the typical handlebar assembly.

FIG. 12 is a side elevation of the embodiment of FIGS. 9-11, shown assembled to a typical handlebar assembly.

FIG. 13 is a front quarter perspective view of a another embodiment of the windscreen assembly of the present invention.

FIG. 14 is an exploded perspective view of the embodiment of FIG. 113 shown together with a typical bicycle aerobar handlebar assembly.

FIG. 15 is a top view of the embodiment of FIGS. 13 and 14; shown assembled to the typical handlebar assembly of FIG. 13.

FIG. 16 is a side elevation of the embodiment of FIGS. 13-15, shown assembled to the typical aerobar handlebar assembly.

### DESCRIPTION OF THE PREFERRED EMBODIMENT

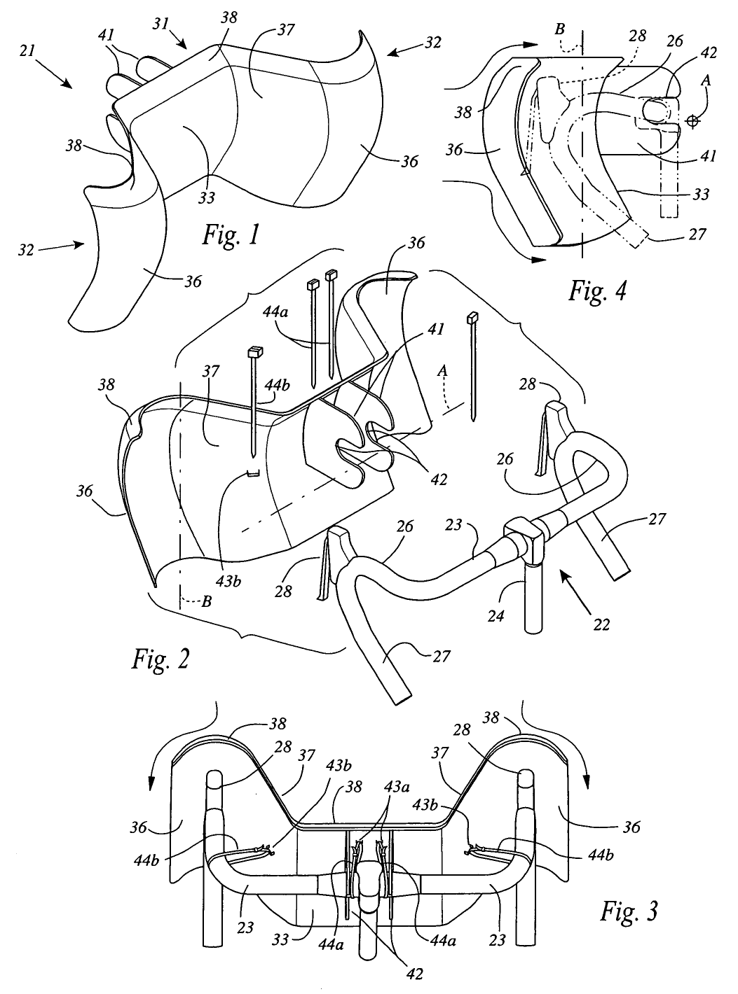

The present invention generally comprises a bicycle windscreen for protecting the hands and arms of a bicycle rider from the oncoming air stream due to the bicycle's forward velocity. With regard to FIGS. 1-4, one embodiment of the windscreen 21 comprises a shell-like assembly that is adapted to be joined to the handlebar assembly 22 of a typical bicycle. The handlebar assembly 22 is provided with a horizontal bar 23 extending laterally from the steering post 24, with outboard handles such as distal ends 26 extending forwardly and then curving downwardly to form drop-style handles 27 for the rider. The hand brakes 28 are typically mounted at the forward apex of the handles 27. As is well known in the prior art, this style of handlebars provides the rider with three different riding positions: grasping the drop handles 27 in a low crouch for maximum aerodynamic effect; holding the brake assemblies 28 in the apex between the thumb and first finger of each hand; and resting the hands on the horizontal bars 23 in an upright posture.

The windscreen 21 is composed of a central portion 31 and a pair of enantiomorphic end portions 32 at opposed ends of the central portion. The central portion 31 includes a manifold 33 that is bent about a nominal horizontal axis A and comprises a longitudinal section of a curved surface such as a cylinder or conic section or any similar smooth curve, or a combination of such surfaces. (Note that the term manifold is used in the mathematical sense to indicate a thin panel that is curved and continuous.) The horizontal axis A of the manifold extends laterally and generally parallel to the horizontal bars 23 of the handlebar assembly. The manifold 33 presents a convex surface to the head wind created by forward velocity of the bicycle. The end portions 32 include a bell-like portion 36 formed of a manifold having a compound curvature that mimics the curvature of central manifold 33 about axis A, and also is curved about a generally vertical axis B. Each portion 36 is connected to the central manifold 33 by an contiguous extension panel 37 that is disposed generally vertically (transverse to axis A) and extends forwardly from the respective end of manifold 33 to the portion 36. Thus the two portions 36 are disposed forwardly of the central manifold 33 a distance that is substantially similar to the forward extent of handlebar portions 26.

Each bell portion 36 is dimensioned in width and height to extend about the front and sides of the respective handlebar parts 26-28, as shown in FIGS. 3 and 4, and the central manifold 33 is dimensioned in length to span the adjacent handlebar portions 23. The central manifold 33, the extension panels 37, and the bell portions 36 may be formed in integral fashion through well-known molding techniques, using material that are readily available. In one preferred embodiment the unit 21 may be formed in a suitable mold using carbon fiber cloth impregnated with a settable resin or polymer to form an extremely strong, lightweight assembly. An upper flange surface 38 extends continuously along the contiguous upper edges of the central manifold 33, the extension panels 37, and the bell portions 36 to form a streamlined airflow over the top edge of the unit 21.

The windscreen unit 21 is secured to the bicycle handlebars 22 by a sturdy mounting system that relies primarily on the counterbalance of tensile forces rather than the struts, braces and clamps of prior art arrangements, whereby a lightweight attachment system is achieved. A pair of standoffs 41 comprise a pair of panels disposed in parallel fashion and each having a proximal edge with a deep notch 42 formed therein. The distal edge of each standoff impinges on the concave curved surface of the manifold 33, and is curved in complementary fashion to form a mating contact with the manifold. The two standoffs 41 may be joined to the manifold 33 by adhesive means, or welding, or any similar known process. The mounting system further includes a pair of loops 43a anchored in the manifold 33 and protruding from the concave proximal surface between the two standoffs 41. A pair of cable ties 44a are passed through the loops 43a and about the handlebar portions 23 on either side of the center post coupling, and tightened to pull the handlebar portions 23 into impingement with the inner edges of notches 42. The tension in ties 44a is opposed by the stiffness of the standoffs, causing the assembly 21 to be immobilized on the handlebar assembly and spaced apart forwardly therefrom.

In addition, a pair of loops 43b are anchored in medial portions of the extension panels 37 and are arranged to protrude from the proximal surface thereof. A pair of cable ties 44b are passed through the loops 43b and about the portions 26 of the handlebars, and tightened to place them under tension. The tension in cable ties 44b is in direct mutual opposition, whereby the windscreen 21 is maintained centered between the handlebar sections 26 by the equilibrium of the countervailing tension in the cable ties 44b. This tension/suspension mounting shrinks the structure and mass required to secure the windscreen assembly 21, reducing the weight to a minimum while providing solid support in all directions.

The loops 43a and 43b may be formed of metal rings or figures that are anchored in the panel material at the time it is formed in the molding process, as is known in the prior art. Alternatively, they may be riveted, welded, joined by adhesive, fastened or otherwise secured to the panel material.

Referring to FIGS. 1 and 3 together, it is noted that the proximal surface of the central manifold 33 is spaced apart a few inches from the handlebar portions 23, and the proximal surfaces of the end portions 32 likewise are spaced apart from and about the handlebar components 26-28. The gap formed between the windscreen assembly 21 and the handlebar assembly defines a wind protection zone in which the hands are not subjected to the chilling effects of the passing airstream. It also allows the bicycle rider to have unfettered manual access to all parts of the handlebar assembly. Thus, for example, the rider may grasp the drop handles 27 for riding at maximum speed, and the portions 36 will deflect all oncoming wind around and away from the rider's hands. Note that the outer edges of the end portions 32 are spaced outwardly of the components 26-28, deflecting the oncoming wind outwardly and away from the handlebar portions 26-28.

Alternatively, the rider's hands may rest on the hoods of brake assemblies 28 and, as shown in FIG. 4, the flared upper edge 38 of the windscreen 21 assembly is spaced above the brake hoods, whereby the hands are also protected from wind when grasping the brake assemblies. Likewise, the windscreen 21 protects the hands when resting on the horizontal handlebar portions 23 for a more upright riding posture. In all cases the rider's hands are protected from the chilling effects of the onrushing wind, which can otherwise can cause pain and numbness in the hands and wrists of the rider.

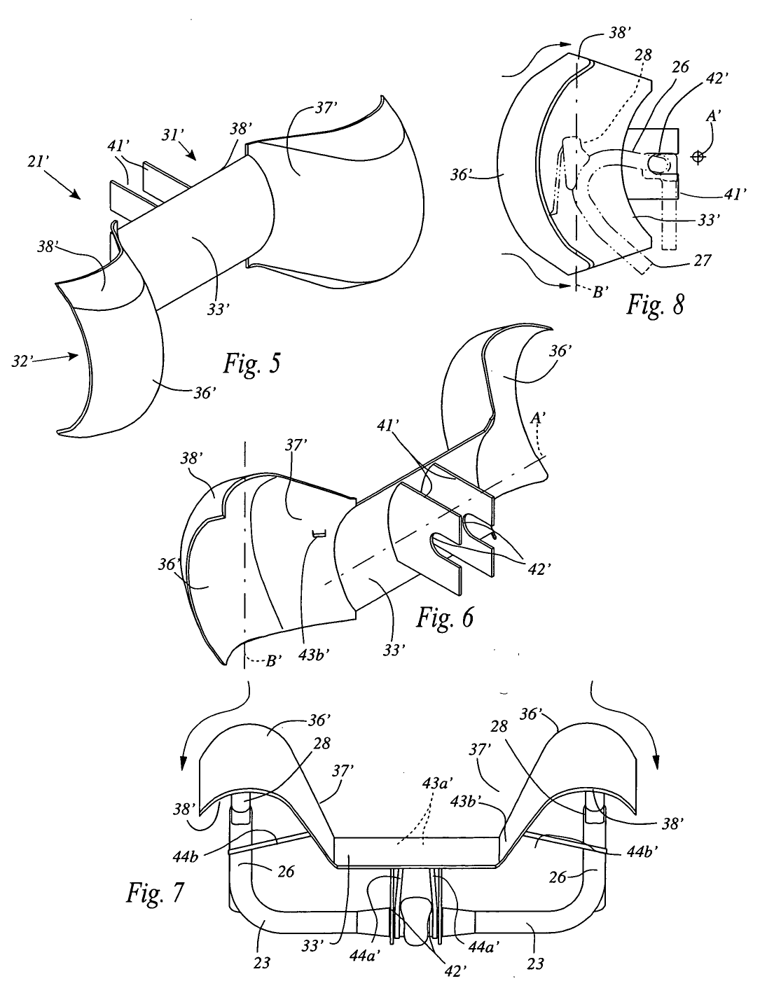

With regard to FIGS. 5-8, a further embodiment of the invention is substantially similar in construction to the previous embodiment, and components common to both embodiments are accorded the same reference numerals with a prime (′) designation. The windscreen assembly 21′ has the same central portion 31′ and end portions 32′, except that the radii of curvature of all components is decreased somewhat, so that the surface curvature is greater. Thus by viewing FIG. 8 in comparison to FIG. 4 is apparent that the bell-like section 36′ at each end has greater curvature and extends higher above the handlebar portions 26. In addition, the extension panels 37′ extend forward to a greater extent, so that the portions 36′ extend more prominently forwardly and about the brake assembly and handlebar components 26-28. The windscreen 21′ provides a larger wind deflection area about the components 26-28, and the increased curvature helps to spill airflow past the bicycle.

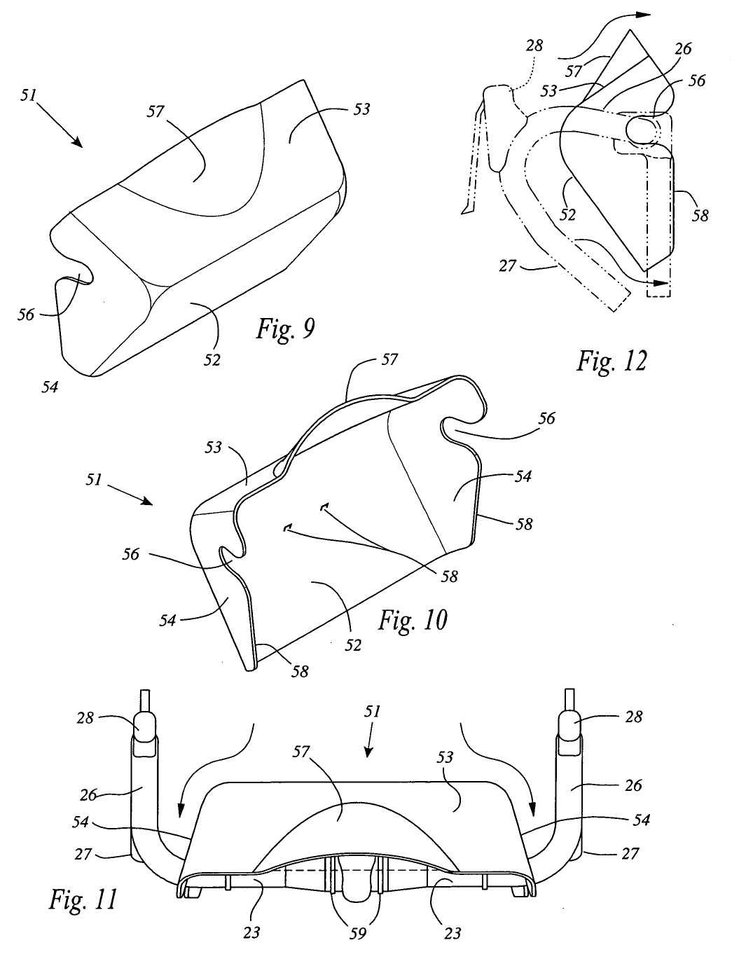

With regard to FIGS. 9-12, a further embodiment of the invention is designed to protect the hands of the rider when they are resting on the horizontal handlebar portions 26, which is the most common riding posture for many riders. The windscreen 51 includes a lower central panel 52 that is generally planar and rectangular, with a horizontal length that is substantially the same as the length of the horizontal handlebar portions 23, and a height that is slightly less than the horizontal dimension. An upper central panel 53 has the same horizontal length as panel 52 and extends in contiguous fashion from a common edge at the upper end of the panel 52. The panels 52 and 53 are disposed at approximately a right angle, although this angle may range many degrees from orthogonal. A pair of side panels 54 each extend in contiguous fashion between the outboard edges of panels 52 and 53, forming a four-sided coffer-like structure. A pair of slot-like notches 56 are formed in the free edge of each side panel 56, and are sized and positioned to engage the horizontal handlebar portions 23, as best shown in FIG. 12. The notches 56 are sufficiently deep so that they rest on the handlebars and support the weight of the windscreen 51.

Note that the proximal edges 58 of side panels 54 are truncated at an oblique angle so that proximal edges taper downwardly from the notch 56 toward the bottom edge of panel 52, and taper upwardly from the notch toward the upper edge of panel 53. In addition, the upper panel 53 may be provided with a convex curved portion 57 flaring upwardly from the medial portion of the upper panel 57 toward the proximal edge thereof. The dome 57 helps to divert the passing airflow upwardly and away from the hands of the rider resting on handlebar portions 23.

The windscreen 51 includes a pair of loops 58 anchored in the lower central panel 52 and protruding from the proximal side thereof along a line that is approximately parallel with the alignment of the notches 56 of side panels 54. A pair of cable ties are passed through the loops 58 and about the adjacent handlebar portions 23, as shown in FIG. 11, and tightened to impinge the portions 23 firmly in the notches 56, whereby the windscreen 51 is secured in place. Note that the side panels 54 are inboard from the handlebar components 26-28, so that these hand supporting components are unprotected by the windscreen 51. On the other hand, the windscreen 51 is small and lightweight, and provides hand protection for the handlebar support components 23, which is where many riders rest their hands most of the time. As described previously, the entire windscreen 51 may be fabricated by molding or stamping any lightweight, thin panel material, and woven carbon fiber fabric impregnated with a settable resin or polymer and molded as a single integral unit is one preferred construction.

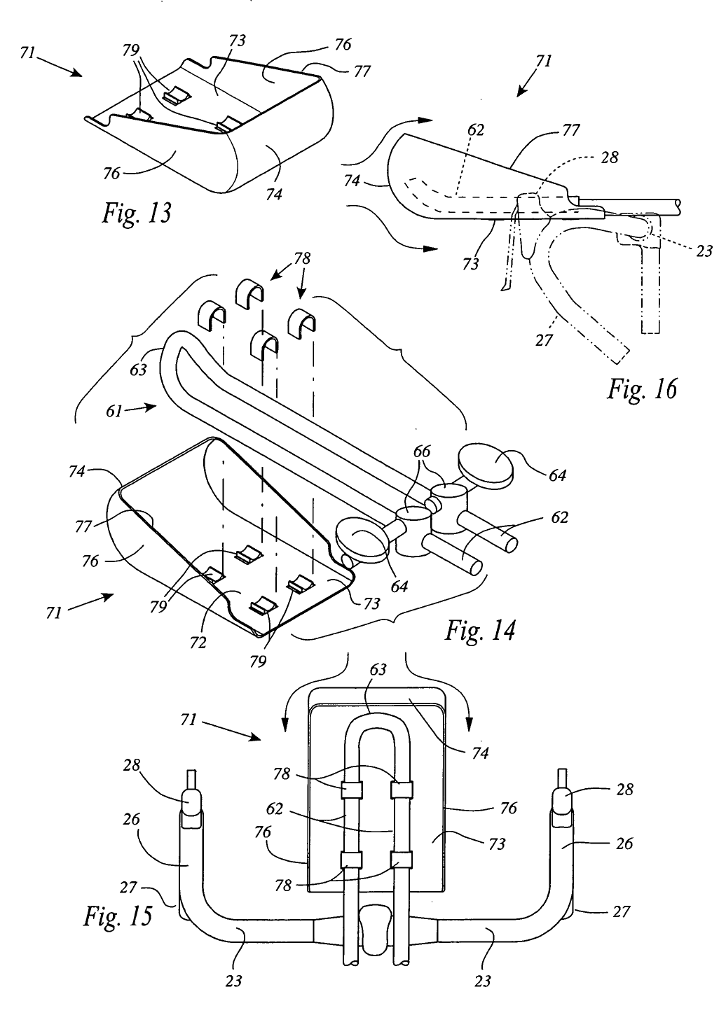

With reference to FIGS. 13-16, a further embodiment of the windscreen of the invention is designed for use with handlebar extensions that project forwardly (distally) from the typical handlebar assembly. These extensions are known in the prior art as aerobars, and they permit the rider to lay out and extend the torso forwardly, resting the elbows on pads at proximal portions of the extensions and grasping the distal end of the extension with both hands, whereby the rider supports the torso with the elbows and steers with the hands on the extension. This arrangement is useful for long rides, and has been adopted, e.g., by many contestants in Ironman competitions.

For example, as shown in FIG. 14 a typical aerobar extension 61 includes a pair of generally parallel support bars 62 extending forwardly from the handlebar portions 23 and supported thereon by clamps or brackets that are known in the prior art and are not shown here. The bars 62 extend generally horizontally and orthogonally to the handlebar portions 23. The bars 62 may be joined at their forward ends to form a grip 63, or may have free ends for grasping. A pair of elbow rests 64 are supported on the proximal portions of the bars 62 by a pair of clamps 66 that are slidably adjustable along the bars 62 to enable accommodation of riders of different sizes and postures. There is a considerable range in configuration and appearance of prior art aerobar assemblies, but they generally have some form of the functional components 62-64 and 66.

The windscreen 71 includes a base panel 72 having a proximal portion 73 that is generally planar and rectangular. The distal portion 74 of panel 72 is curved upwardly through an angle that is greater than 90°, forming a J-shaped configuration that presents the convex surface of the J form to the oncoming airflow. A pair of side panels 76 each extend contiguously to span the longitudinal edges of the proximal portion 73 and distal portion 74 of a respective side of the base panel 72, the side panels extending generally orthogonally to the plane of the proximal portion 73 of the base panel. The upper edges 77 of side panels 76 are tapered from the conjunction with distal end at portion 74 to the opposed end of proximal portion 73 of the base panel. The base panel and side panels form a coffer-like structure that opens upwardly.

Secured to the proximal portion 73 of the base panel are a two pairs of resilient pads 79 that have upper surface formed in complementary fashion to the curvature of the bars 62, each pair being aligned longitudinally to impinge on the same bar 62. The windscreen 71 also includes two pair of clamping devices 78 that are releasably secured about the bars 62 at the pads 79 to secure the bars 62 to the windscreen 71, whereby the windscreen is supported entirely by the bars 62. The pads 79 prevent the windscreen from rattling against the bars 62 and generating noise and wear. The devices 78 may comprise retention straps, cable ties, hook and loop fasteners, and the like. Thus the windscreen is easily installed on and removed from the bicycle.

Note that the length and width of the windscreen 71 is slightly greater than the comparable dimensions of the bars 62. The J configuration forms a streamlined airflow up and over and about the convex surface of the distal end of the windscreen. When the bicycle rider is in the aerobar layout position, the windscreen 71 encloses the hands and forearms of the rider to protect them from the chilling effects of the passing airflow, while permitting unfettered use of the aerobar and unrestrained steering of the bicycle.

As described previously, the entire windscreen 71 may be fabricated by molding or stamping any lightweight, thin panel material, and woven carbon fiber fabric impregnated with a settable resin or polymer and molded as a single integral unit is one preferred construction.

Thus the invention provides a windscreen for the hands of the bicycle rider that is lightweight and minimal in size. It is attached only to the handlebar assembly, eliminating any substructure or links to the forks or frame of the bicycle. The various embodiments describe alterative windscreen designs of curved manifolds for protecting the hands and arms of the rider, whether in the drop handle position, grasping the brake lever assemblies, or resting on the central horizontal handlebar portions. There is also a windscreen for protecting the hands and arms of the rider when using an aerobar support on the handlebar assembly. The use of cable ties to attach the windscreen to the handlebar assembly, and the use of cable ties to secure the windscreen to the handlebar under a lateral tension/suspension arrangement, results in a secure mount with a minimum of structure and mass.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. A windscreen assembly for diverting the oncoming airflow of a bicycle around the rider's hands when resting on the bicycle handlebars, including:
a central panel assembly including a first manifold having a convex surface extending to impinge on the oncoming airflow and divert the airflow around the central panel assembly;
attachment means for securing said central panel assembly to the handlebars, said attachment means maintaining said convex surface impinging on the oncoming airflow.

2. The windscreen assembly of claim 1, wherein the handlebars include a pair of collinear horizontal portions extending laterally, and said first manifold is curved about a horizontal axis extending laterally and adjacent said pair of collinear horizontal portions, whereby said first manifold curves about the horizontal portions of the handlebars.

3. The windscreen assembly of claim 2, wherein said attachment means includes means for maintaining said first manifold spaced apart from the horizontal portions of the handlebars and forwardly thereof and defining a wind protection zone between said manifold and the horizontal portions of the handlebars.

4. The windscreen assembly of claim 3, wherein said attachment means further includes at least one standoff secured to said manifold and disposed to impinge on the horizontal portions of the handlebars.

5. The windscreen assembly of claim 4, wherein said attachment means further includes at least one tension member extending from said manifold to loop about at least one of the horizontal portions of the handlebars, said tension member compressing said at least one standoff between said manifold and said horizontal portion of the handlebars to secure said manifold to the handlebars.

6. The windscreen assembly of claim 5, further including a pair of said standoffs disposed in parallel, laterally spaced apart fashion.

7. The windscreen assembly of claim 6, further including a pair of said tension members disposed between said pair of standoffs.

8. The windscreen assembly of claim 5, wherein said first manifold has a concave surface on the opposite side of said convex surface, said attachment means further including at least one anchor loop protruding from said concave surface and adapted to engage said at least one tension member.

9. The windscreen assembly of claim 2, wherein said central panel assembly further includes a pair of end portions, each extending from a laterally opposed end of said first manifold, each end portion including a second manifold that is curved about said horizontal axis and is further curved about a vertical axis to form a bell-shaped configuration that extends partially about the outboard handle end of the handlebar assembly.

10. The windscreen assembly of claim 9, wherein the handlebars include a pair of outboard handle ends, each extending to a respective one of said horizontal portions of the handlebars and connected thereto, and said attachment means includes tension/suspension means extending between said pair of outboard handle ends and said pair of second manifolds.

11. The windscreen assembly of claim 10, wherein said tension/suspension means includes a pair of tension members, each connected between one of said outboard handle ends and a respective one of said end second manifolds, the tension in each of said pair of tension members counterbalancing the effect of the other to maintain said windscreen secured laterally between said outboard handle ends.

12. The windscreen assembly of claim 9, wherein said first and second manifolds are formed integrally of a thin panel of high strength, low density material.

13. The windscreen assembly of claim 1, wherein said first manifold includes a coffer-like structure having a lower central panel, an upper central panel extending transversely from an upper edge of said lower central panel, and a pair of side panels spanning the like-sided edges of said upper and lower central panels.

14. The windscreen assembly of claim 13, wherein the handlebars include a pair of collinear horizontal portions extending laterally, and said attachment means includes a pair of slot-like notches, each extending into a proximal edge of a respective one of said side panels, each of said notches being dimensioned to engage and receive one of said horizontal portions of said handlebars.

15. The windscreen assembly of claim 14, wherein said attachment means further includes at least one tension member extending from said first manifold to loop about at least one of the horizontal portions of the handlebars, said tension member maintaining said horizontal portions of said handlebars in said notches to secure said first manifold to the handlebars.

16. The windscreen assembly of claim 1, further including an aerobar assembly extending generally forwardly and horizontally from said handlebars, said first manifold including a base panel having a proximal flat portion and a J-like curvature at a forward end thereof, and said attachment means includes means for securing said base panel to the aerobar assembly with the convex surface of said J curvature extending to receive the oncoming airflow.

17. The windscreen assembly of claim 16, further including a pair of side panels extending to span the like-sided edges of said proximal flat portion and said forward end of said base panel.

18. The windscreen assembly of claim 16, wherein said attachment means includes at least one resilient pad interposed between said base panel and the aerobar assembly, and at least one tension member extending about the aerobar assembly at said at least one resilient pad to secure said base panel to the aerobar assembly.
